(19) United States
(12) Patent Application Publication
(10) Pub. No.: US 2026/0240089 A1
(43) Pub. Date: Aug. 20, 2026

(54) MOBILE WORK MACHINE AND METHOD FOR A WORK MACHINE

(71) Applicant: PONSSE OYJ, VIEREMÄ (FI)

(72) Inventors: Joni BACKAS, VIEREMÄ (FI); Jarmo UDD, VIEREMÄ (FI); Ville AHOLA, VIEREMÄ (FI)

(73) Assignee: PONSSE OYJ, VIEREMÄ (FI)

(21) Appl. No.: 19/489,623

(22) PCT Filed: Jun. 6, 2025
(86) PCT No.: PCT/FI2024/050294

§ 371 Date: Dec. 3, 2025

(30) Foreign Application Priority Data
Jun. 7, 2023 (FI) 20235630

(51) Int. Cl. A01G 23/00; B66C 23/90

(52) U.S. Cl. CPC A01G 23/003; B66C 23/905

(57) ABSTRACT

A mobile work machine, which includes
a knuckle boom crane for lifting loads including at least two booms articulated to each other and actuators for moving the booms,
a tool fastened to the knuckle boom crane for grabbing a load,
a control system for controlling the knuckle boom crane at least partially automatically, the control system including a database including at least one control rule for protecting the knuckle boom crane from overloading, and the control system is programmatically arranged to protect the knuckle boom crane based on the control rule by limiting the operation of the actuators before the actual use of the knuckle boom crane for lifting or handling a load.

The disclosure is also related to a method in controlling a mobile work machine.

### FIELD

The aspects of the disclosed embodiments is related to a mobile work machine, which includes:
a knuckle boom crane for lifting loads comprising at least two booms articulated to each other and actuators for moving the booms,
a tool suspended from the knuckle boom crane for grabbing a load,
a control system for controlling the knuckle boom crane at least partially automatically.

The aspects of the disclosed embodiments is also related to a method for a mobile work machine.

### BACKROUND

In mobile work machines, such as forest machines, particularly high loads are exerted on the knuckle boom crane when lifting a load with a tool using the maximum reach of the knuckle boom crane, that is, in a situation where the distance between the suspension point of the tool fastened to the knuckle boom crane and the joint fastening the knuckle boom crane to the tool is at its maximum. Stresses are generally avoided in the manufacture of work machines by limiting stresses applied to the knuckle boom crane via design regulations by limiting the reach of the knuckle boom crane. In practice, this may mean, for example, that the pivoting of the articulated booms of a knuckle boom crane in relation to each other for increasing the reach of the knuckle boom crane has been limited by the use of actuators that prevent the booms from extending out parallel to each other. Alternatively, in the case of knuckle boom cranes with extension booms, for example, the choice of the length of the extension boom can directly influence stresses applied to the knuckle boom crane at its maximum reach.

The problem with such a limitation for a knuckle boom crane based on design regulations is the fragmentation of production to different implementations according to the tool used. Own weights and other characteristics of known tools can vary significantly between tools, and choosing one tool over another can either increase or decrease the stresses applied to a knuckle boom crane when operating at the maximum reach. The fragmentation of production leads to additional costs in the production and also makes the maintenance of work machines more difficult by making it more complex with several different models.

In addition, if a different tool is to be substituted for the tool on which the original design regulation is based, the potential of the work machine may not be exploited effectively due to the limitations of the knuckle boom crane.

Publication WO 2020256614 A1 representing prior art proposes a method and arrangement for managing the lifetime of a wood handling system by determining the loads exerted on the crane included in the system during the operation of the crane. The method for monitoring the load is based on monitoring the load during operation and monitoring the cumulative load according to Claim 1 of WO 2020256614 A1. The load is monitored and compared with the load limitation curve with the aim of preventing the load from entering this range. The problem with this solution, however, is that it requires the work machine to perform complex and continuous real-time load calculations, which is expensive to implement. In addition, it is attempted to avoid loading after loading takes place, which can result in overloading the crane.

### SUMMARY

The object of the aspects of the disclosed embodiments is to provide a mobile work machine that is more cost-efficient to manufacture, more versatile in terms of usability and more robust than prior art work machines. The aspects of the disclosed embodiments are characterized by a work machine including a knuckle boom crane for lifting loads, comprising at least two booms articulated to each other and actuators for moving the booms, a tool suspended from the knuckle boom crane for grabbing a load, a control system for controlling the knuckle boom crane at least partially automatically. The control system includes a database comprising at least one control rule for protecting the knuckle boom crane from damage, and the control system is arranged to protect the knuckle boom crane programmatically by limiting the operation of the actuators before the actual use of the knuckle boom crane for lifting or handling a load, based on the control rule.

Henceforth, the simplified term “crane” will be used for the knuckle boom crane in the description part of the application.

Thanks to the programmatical reach limitation, the potential of the mobile work machine can be seized regardless of the tool used on the crane, without applying excessive stress on the crane. In other words, when using a light tool, the crane is subjected to lower loads and the usable reach of the crane within the permitted loads is higher, even the physical maximum reach of the crane. Instead, when a heavy tool is used with the crane, the crane's reach can be programmatically limited by the control system by influencing the operation of the actuators, thus keeping the crane load within the load limits. On the other hand, the use of a control rule can also ensure that, during a lift with a given reach, the crane will certainly have sufficient force to perform the lift safely.

Preferably, the control rule is a control rule that prevents overloading of the knuckle boom crane. In this way, the mechanical implementation of the mobile work machine can enable the use of the crane over its entire operating range, with any overload prevented by the control rule.

The use of a control rule makes it possible to dispense with certain design regulations that have been previously used to limit the maximum physical reach of the crane in the manufacture of the work machine and enables a safe maximum reach of the crane in all situations. In some situations, it is even possible to increase the physical maximum reach of the crane as the force exerted on the crane can be limited according to the situation by limiting the reach.

Preferably, the control rule is related to one or more of the following: the reach, lifting load or transfer speed of the knuckle boom crane. Each of the above has relevance on the loads exerted on the crane.

In this context, the load limits are the maximum forces on the crane specified for the crane by the equipment manufacturer. Exceeding these values may result in damage to the crane or the work machine in some period of time.

Preferably, the control rule includes a condition, upon the fulfillment of which the crane actuator control limitations or limited control commands contained in the control rule are enabled. For example, the condition may be a model-specific name of a tool, which the control system compares with the information of the tool in use.

Preferably, the fulfillment of the condition is monitored by software means. In this way, the fulfillment of the condition is detected and the control system starts to act according to the control rule.

Preferably, the control rule is tool-specific. In other words, the control rule is determined based on the tool attached to the crane so that the loads imposed on the crane by different tools can be taken into account.

Preferably, the control rule includes a tool-specific reach rule limiting the maximum allowable reach of the knuckle boom crane, or a tool-specific lifting force rule limiting the maximum allowable lifting force of the knuckle boom crane at each reach of the knuckle boom crane, or both.

According to an aspect of the disclosed embodiments, the crane has a physical maximum reach and the control rule is a reach rule, which is a tool-specific maximum allowable programmatically limited reach of the crane when using a tool; thus, when the reach rule is followed, the control system is arranged to protect the crane by limiting the reach of the crane to less than the maximum reach. In this way, according to the force applied to the crane by the tool used, the operator's available reach can be programmatically limited without the need for physical limitations on the crane's travel path. In other words, the reach is only limited when necessary, that is, the maximum reach is used when the rule allows it.

According to another embodiment, the knuckle boom crane has a maximum lifting force and the control rule is a lifting force rule, which is a tool-specific programmatically limited maximum lifting force of the knuckle boom crane at each reach of the knuckle boom crane; thus, when the lifting force rule is followed, the control system is arranged to protect the knuckle boom crane by preventing the knuckle boom crane from lifting when the maximum lifting force is exceeded. If the full crane reach is in use according to the tool used, the need to limit the lifts within the required lifting force can still be observed to ensure that the crane is protected against heavy loads.

Preferably, there are at least two control rules, including at least a reach rule and a lifting force rule. The above rules complement each other, since if one rule is not used, the other can protect the crane from damage.

The database may include at least one allowable deviation criterion for a deviation from a control rule, where the control system is adapted to override the control rule if the deviation criterion is met. A deviation may be necessary in exceptional situations, such as when a crane is being serviced, where, despite the tool used, the crane may need to be run at its physical maximum reach when it is known that the crane will not be subjected to other loads during a maintenance situation and will not be used to perform lifts at the maximum reach.

Preferably, the work machine includes a selector or control for the operator, the manual operation of which is the deviation criterion. In this case, a manual decision by the operator can override the control rule in situations where the operator has been given permission to deviate from the control rule. The use of exceptions simplifies the control system design, as the automation does not have to take into account all exceptions, but they can be performed manually.

According to an embodiment, the operator may also be artificial intelligence.

The control system may include a sensor to determine the position data of the boom assembly, storage means for storing the position data, the control rule and the software means controlling the crane, and a calculation unit for determining the commands required to control the crane for the crane actuators based on the position data and control rules.

Preferably, the storage means consist either of a memory on the mobile work machine or a storage medium, such as a cloud service, accessed from the mobile work machine via a wireless network connection for storing the data.

Preferably, the mobile work machine is a forest machine and the loads lifted by the knuckle boom crane are trees. In the case of forest machines, it is important to maximize the crane's reach without overloading the crane, as the forest machine is intended to deviate as little as possible from the planned route in the forest, as the forest machine can cause damage to undergrowth and seedlings. In this way, forest machines aim to fell and handle trees from the roadway, which increases the use of the crane at or close to the maximum reach. In addition, lifting operations are repeated dozens or hundreds of times a day, which increases the stress on the crane. Furthermore, there is a considerable number of different tools available for forest machines, preferably felling heads or grapples, which vary greatly in mass and characteristics. It is therefore important to maximize the use of the crane when using any tool while protecting the crane from excessive stress. In this context, the term “trees” refers not only to felled tree trunks, but also to cuttings and other parts of the felled tree.

Preferably, the control system on a forest machine is a crane tip control system. This means that an existing control system can be used for limiting the reach with software modifications, without the need to introduce additional equipment to the forest machine.

Preferably, in the forest machine, booms include an extension boom comprising a telescopically movable extension, and actuators include a first actuator to operate the extension of the extension boom, and the control system is arranged to control the operation of the first actuator for limiting the reach of the crane to a programmatically limited reach.

Most preferably, the mobile work machine according to the aspects of the disclosed embodiments is a forest machine in which the control system is a crane tip control system and the crane includes an extension boom comprising an extension, and further, the control rule of the control system is arranged to programmatically limit the length of the extension with the tool used in the forest machine. Such an embodiment is quite simple to implement in existing forest machines using existing components.

A forest machine may include an observation system for generating observations of trees surrounding the forest machine and storing the observations in another database, where the observation includes one or more of the following tree characteristics: diameter, species, location, length, volume, size, dimensions; and the control system is arranged to use the observations to implement an actuator limitation according to the control rule. This allows to take into account the lifting force generated by the lifting based on the observation system and utilize the information to limit actuator functions where necessary.

Preferably, the database includes a correlation for the lifting force rule, which is a function of the lifting force exerted by the lifting of the tree on the knuckle boom crane and the current reach of the knuckle boom crane.

According to an embodiment, if the lifting force is expected to be particularly low based on observations, this can be used as a deviation criterion, which enables a lifting event to occur from a reach greater than the reach limited based on the control rule.

Preferably, the control system is arranged to modify the control rule based on observations. This allows to take into account the lifting force due to the lifting based on the detection system and modify the rule accordingly.

The database may contain a correlation for the lifting force rule, the correlation being a function of the lifting force of the tree lift on the knuckle boom crane and the current reach of the knuckle boom crane, and further, the control system is arranged to retrieve the observation from another database, calculate the estimated mass of the tree based on the observation, determine an adaptive maximum allowable reach based on the maximum allowable reach and correlation, and limit the reach of the knuckle boom crane according to the adaptive maximum allowable reach. Such a refined system enables the monitoring of the mass of the trees to be lifted and active adjustment of the maximum available reach on a tree-by-tree basis. That is, for example, if the control system determines that the mass of the tree to be lifted is such that the maximum load of the crane would be exceeded with the reach used, the control system will prevent the lifting or limit the reach of the crane to the permitted area, outside of which access is programmatically prevented.

The preferred tool used on a forest machine is a felling head, that is, a harvester head. Own weights of different felling heads vary considerably and this has a major impact on the available safe maximum reach.

Preferably, the actuator is a cylinder actuator. Cylinder actuators are currently the actuators that are most commonly used on the cranes of mobile work machines, as a hydraulic power take-off is generally available on mobile work machines.

Alternatively, actuators can be electric, preferably spindle motors, for example. The use of electric actuators will become more common as the power source for mobile work machines is shifting from internal combustion engines to electric propulsion systems.

Another object of the aspects of the disclosed embodiments is to provide a method for a mobile work machine, which is better and simpler than prior art methods, allowing the potential of the work machine to be exploited to the maximum with the selected tool while ensuring that the work machine is not damaged during operation. The aspects of the disclosed embodiments are characterized by a method for a mobile work machine wherein the mobile work machine includes a knuckle boom crane for lifting loads, comprising at least two booms articulated to each other and actuators for moving the booms, a tool suspended from the knuckle boom crane for grabbing a load, and a control system for controlling the knuckle boom crane at least partially automatically. In addition, the control system includes a database comprising at least one control rule for protecting the knuckle boom crane from damage. The method involves controlling the knuckle boom crane at least partially automatically using the control system for gripping a load and protecting the knuckle boom crane using the control system based on the control rule by programmatically limiting the operation of the actuators before the knuckle boom crane is used to lift or handle the load.

In this context, “limiting” may mean a partial or total limitation of the movement range of the actuators or limitation of the speed of movement of the actuator or any similar measure affecting the force exerted on the crane.

A method according to the aspects of the disclosed embodiments enables active protection of the crane in all situations of use when the limitation to the reach of the crane is provided programmatically and not via physical limitations as in prior art systems. In addition, a programmatical limitation enables utilization of the full reach in situations where limitation is not necessary.

Preferably, the tool is selected from a set of different tools. Each tool has its own characteristics, which can be taken into account with control rules.

According to an embodiment, tools are classified by weight classes, the tool currently used is registered in the control system, the weight class of the tool used is retrieved and load applied to the crane is limited with the control rule taking into account the weight class of the tool.

Preferably, the method creates a database before the lifting of a load by entering information on the maximum reach of the crane allowed to be used with different tools.

Preferably, the control rule includes a condition, upon the fulfillment of which the operation of the crane actuators is limited according to the control rule.

Preferably, the control system monitors the fulfillment of the condition and executes the control rule when the condition is fulfilled.

According to an aspect of the disclosed embodiments, a knuckle boom crane has a physical maximum reach and the control rule is a reach rule, which is a tool-specific maximum programmatically limited reach of the knuckle boom crane when using the tool, thus, when the reach rule is followed, the control system protects the knuckle boom crane by limiting the reach of the knuckle boom crane to less than the maximum reach. This avoids using the crane in an area of the reach where damage to the crane would be likely, at least in the long term.

According to another embodiment, the knuckle boom crane has a maximum lifting force and the control rule is a lifting force rule, which is a tool-specific programmatically limited maximum lifting force of the knuckle boom crane for each reach of the knuckle boom crane, wherein, when the lifting force rule is followed, the control system protects the knuckle boom crane by preventing the knuckle boom crane from lifting when the maximum lifting force is exceeded. The lifting force rule can be used to prevent lifting altogether if the lifting force generated by the load is likely to damage the crane.

Preferably, the method uses a forest machine as the mobile work machine and trees as the loads to be lifted, and observes the surrounding trees to form observations and adaptively protects the knuckle boom crane based on the observations and the control rule. The method according to the aspects of the disclosed embodiments is particularly suitable for use with forest machines because a forest machine crane performs a large number of repetitive lifts at or near the maximum reach of the crane.

A knuckle boom crane can be protected adaptively based on observations and a control rule in the following steps performed by the control system: calculate the estimated mass of the tree based on the observation, determine the adaptive maximum allowable reach using the maximum allowable reach and correlation, and limit the reach of the knuckle boom crane according to the adaptive maximum allowable reach. The limitation of the adaptive reach allows each lift to be observed and a decision to be made as to what is the maximum allowable reach available and what is the maximum allowable lifting force for a given reach.

Preferably, the method involves entering a tool ID into the control system database manually by the operator or installer, either locally or remotely. Alternatively, the control system can also automatically identify the tool by means of an electrical, optical, mechanical or similar identifier, or even by weight. Preferably, the tool ID is used to retrieve the parameters of the control rule from the system memory or from another database. Alternatively, the parameters of the control rule can be manually entered with the selected tool.

In addition to the tool, there may also be other factors that influence the control rule, for example, different countries may have different regulations and the stand may be different, for example, a forest machine that is only going to work on eucalyptus may have different control rules than a forest machine working in the northern coniferous forest zone.

In this application, the term “reach” refers to the distance from the point of attachment of the crane tool to the pivot point that attaches the crane to the mobile work machine. The maximum reach, in turn, refers to the maximum length of the reach when the crane is turned to extend as far as possible from the pivot point of the crane.

In this application, the term “control rule” means an instruction for controlling the crane, stored in the database used by the control system, which is executed when the condition set for the instruction is fulfilled. This condition may be, for example, the model of the tool to be used, upon fulfillment of which the control rule takes effect.

Preferably, the control rule is arranged to limit the reach, prevent lifting or limit the speed of movement to prevent the maximum load value from being exceeded.

In this application, the term “deviation criterion” means a specific condition that allows a deviation from the control rule, even if the condition of the control rule is fulfilled and the control system would normally control the crane in accordance with the control rule. A deviation criterion can be, for example, a deviation condition that is manually activated by the operator, such as a maintenance condition. Alternatively, the deviation criterion can be, for example, a specific tool that allows to deviate from the control rule when it is used without fear of damaging the crane during use.

The idea of the aspects of the disclosed embodiments can be briefly summarized as mechanically allowing a maximum deviation for a work machine crane and limiting the maximum deviation programmatically.

If the method is used in conjunction with an environmental observation system, an exception can be made for light loads with respect to the limitation of the reach of the crane, or alternatively, if the reach of the crane is short, an exception can be made for the weight of the load to be lifted, however, in such a way that the crane is not stressed beyond predetermined limits.

### BRIEF DESCRIPTION OF THE DRAWINGS

The aspects of the disclosed embodiments, which is not restricted to the embodiments presented below, is described in more detail by making reference to the enclosed drawings, in which:

FIG. 1a is a lateral view of a forest machine for felling and handling trees,

FIG. 1b is a lateral view of a forest machine for collecting trees,

FIG. 2a shows a crane according to the first embodiment with the minimum reach,

FIG. 2b shows a crane according to the first embodiment with the maximum reach,

FIG. 3a shows a crane according to the first embodiment with the minimum reach,

FIG. 3b shows a crane according to the first embodiment with the maximum reach,

FIG. 3c shows a crane according to the first embodiment with a limited maximum reach,
FIG. 4 shows a simplified basic structure of a control system of a mobile work machine,

FIG. 5 shows a block diagram of the steps of the method according to the aspects of the disclosed embodiments.

### DETAILED DESCRIPTION

Next, the mobile work machine and the method for controlling the mobile work machine according to the aspects of the disclosed embodiments are described with reference to a preferred embodiment in which the mobile work machine is a forest machine and the loads to be lifted with the crane are trees. However, it should be understood that instead of a forest machine, the mobile work machine could be a truck or a tractor equipped with a crane to lift loads into a load space, or an excavator with a bucket at the end of the crane.

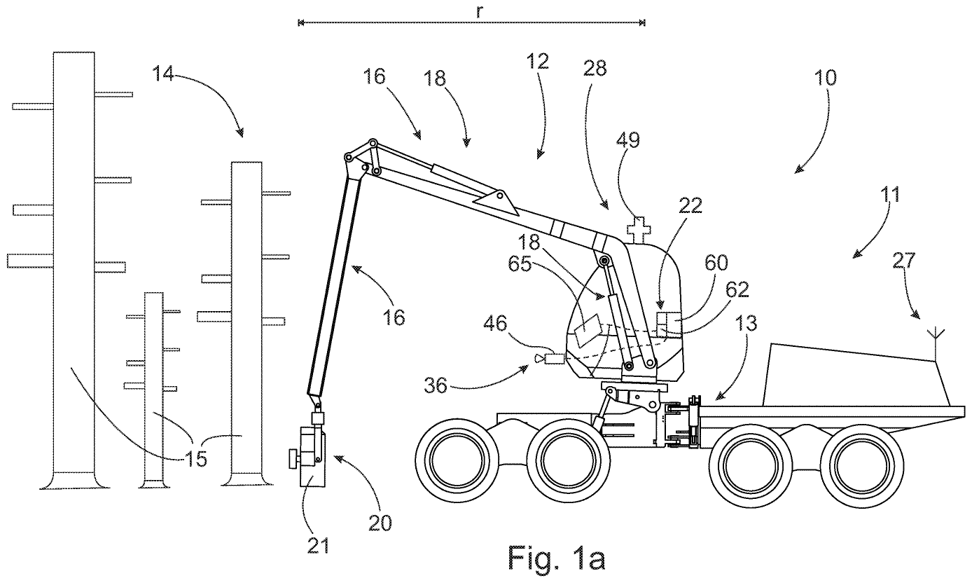

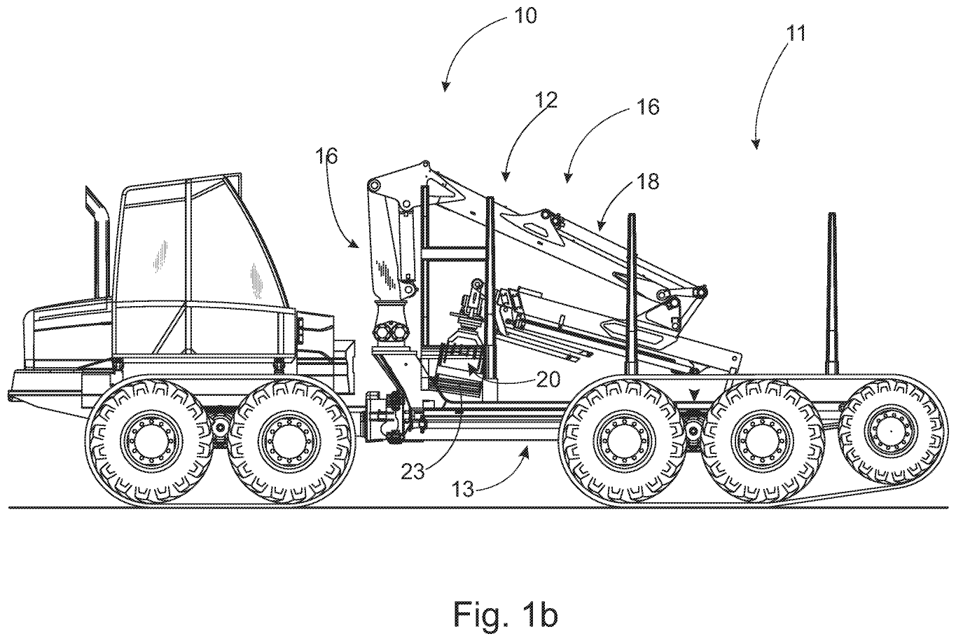

FIG. 1a shows a forest machine 11 as a mobile work machine 10 for felling and handling trees 15. The work machine of FIG. 1a may also be referred to as a harvester, wherein the crane 12 of the forest machine 11, which acts as a chassis machine, has a felling head 21, or harvester head 20, attached to it as a tool. In particular, when using harvesters, it is often desired to operate with the chassis machine in a certain path and the felling of trees is done by reaching as far as possible with a crane without moving the chassis machine in the direction of the trees to be felled any more than necessary. This avoids damage to the forest undergrowth and seedlings from the weight of the harvester. In this case, the crane often has to be operated at high, even maximum, reach.

In this context, a harvester is a forest machine consisting of a crane and a felling head, i.e. a harvester head suspended from the crane. In turn, a forest machine is a mobile work machine for moving around in the forest and handling trees, comprising a wheeled or tracked chassis and a crane.

In turn, as the mobile work machine 10, FIG. 1b shows a forest machine 11, which is used to collect the trees 15 already felled. The work machine of FIG. 1b may also be referred to as a forwarder, wherein the crane 12 of the forest machine 11, acting as a chassis machine, has a grapple 23 attached as a tool 20. Also when using forwarders, the aim is to avoid unnecessary movement in the forest in order to avoid damage to the forest undergrowth and seedlings from the weight of the forwarder.

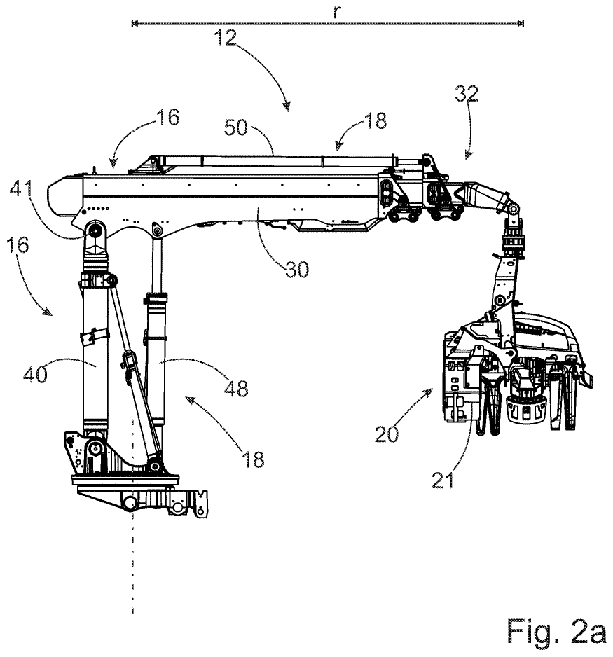

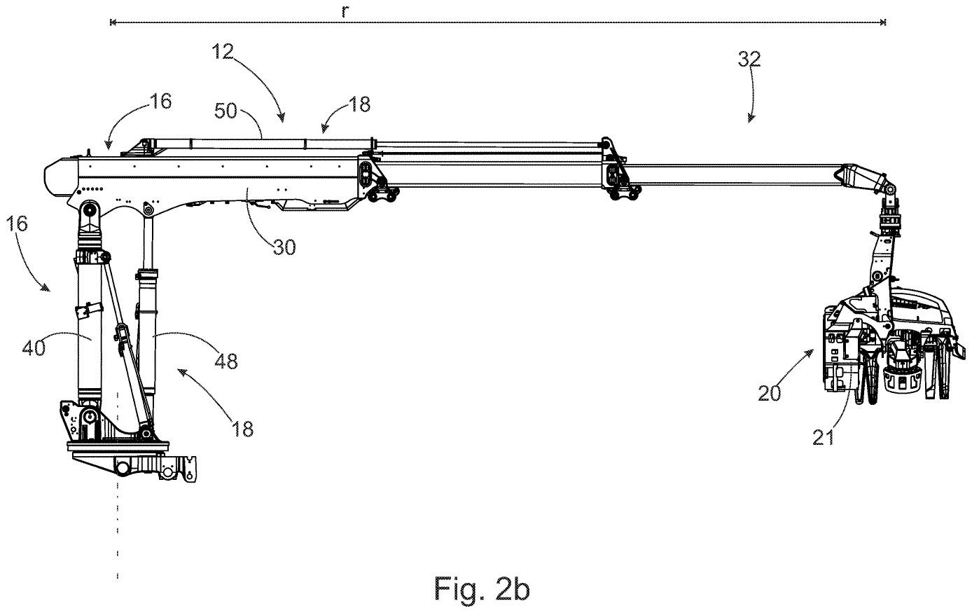

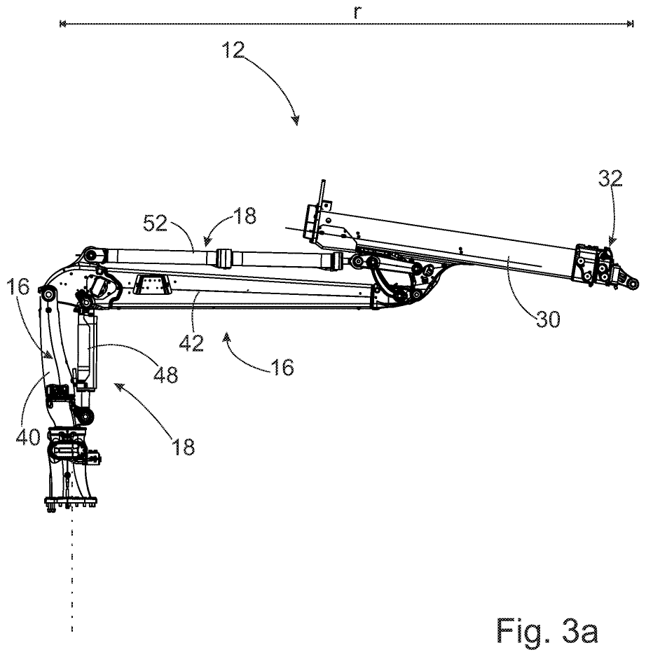

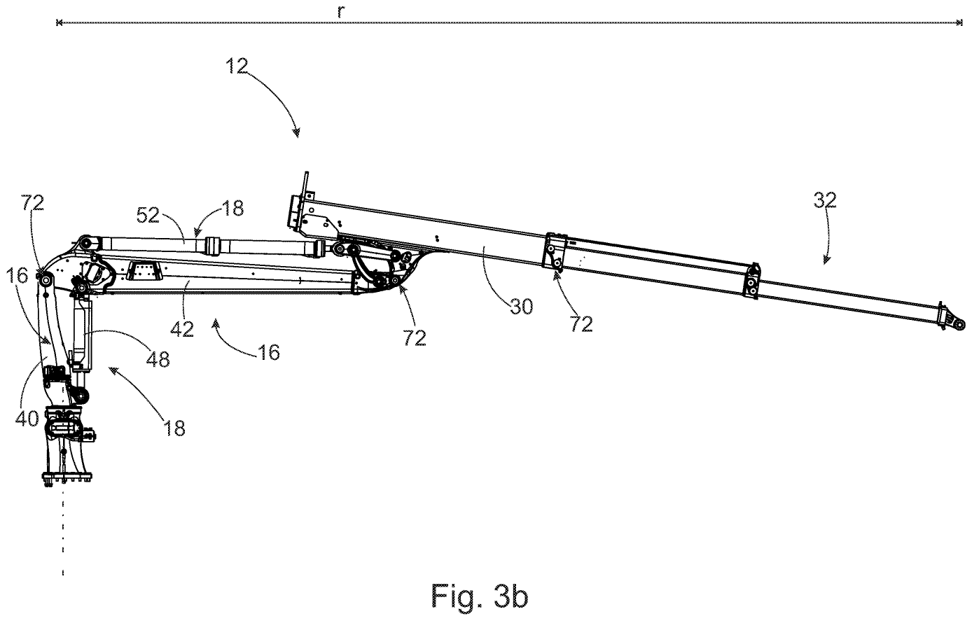

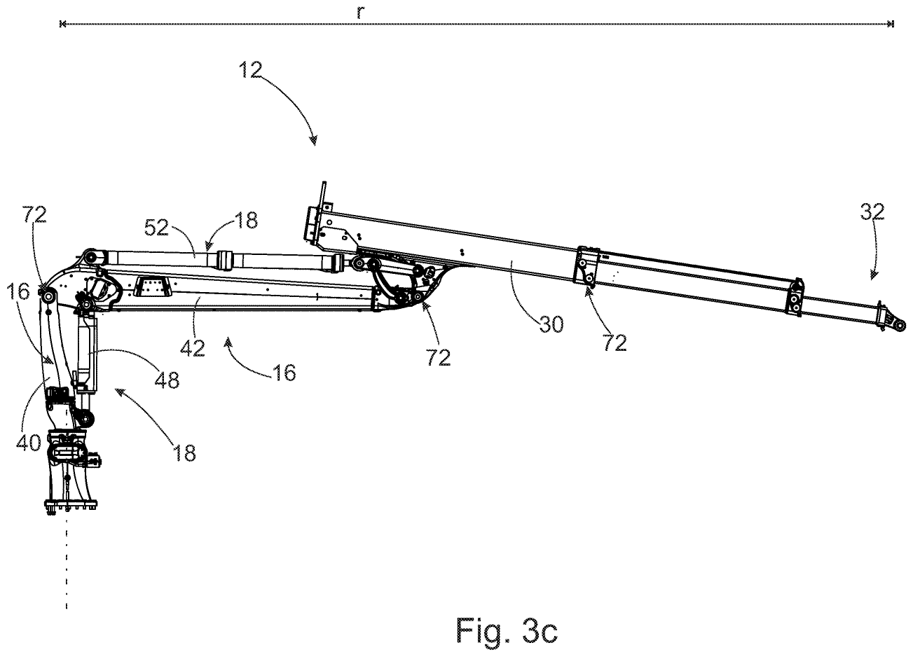

The mobile work machine 10 according to the aspects of the disclosed embodiments, a forest machine 11 in the case of FIGS. 1a and 1b, includes as components a knuckle boom crane 12 for lifting loads 14, preferably trees 15 shown in FIG. 1a, comprising at least two booms 16 articulated to each other and actuators 18 for moving the booms 16. FIGS. 1a and 1b show only roughly conventional types of crane for forest machines, wherein the booms 16 comprise a pillar boom 40 and an extension boom 30 articulated in a circular rotation to the frame 13 of the forest machine 11 of the crane 12, shown in FIGS. 2a to 3c, either articulated directly to the end of the pillar boom 40 as shown in FIG. 2a or alternatively articulated to the main boom 42 as shown in FIG. 3a, wherein the extension boom 30 is articulated to one end of the main boom 42. The extension boom 30 preferably includes a telescopic extension 32, the length of which can be varied to influence the reach r of the crane. The actuators 18 allow the angle between the booms 16 to be adjusted, as well as the length of the extension boom 30, thereby affecting the reach r of the crane.

FIGS. 2a and 2b illustrate the design of the crane 12 according to a first embodiment of the aspects of the disclosed embodiments in greater detail. Suspended as a tool 20 from the end of this crane 12, there is a harvester head 21, which can be used for felling and handling trees. In this embodiment of the crane, the crane only includes a pillar boom 40 and an extension boom 30 as booms 16, which are articulated to each other with a transverse joint 41. The extension boom 30 includes a telescopic extension 32, which is shown in FIG. 2a at its minimum dimension and in FIG. 2b at its maximum dimension. However, the dimension of FIG. 2b is not the full maximum reach of the crane 12, as the maximum reach is achieved by tilting the pillar boom 40 towards the tree from the vertical position of FIGS. 2a and 2b. In the crane 12, the pillar boom is articulated to the frame 13 of the forest machine 11 with a vertical joint as shown in FIG. 1a. Thus, the crane 12 is a vertical joint allowing the crane to rotate 360°. In the crane 12, the actuators 18 in this case comprise a lifting cylinder 48 and an extension cylinder 50. Preferably, the cylinders are hydraulic cylinders, but it should be understood that electric linear actuators, such as spindle motors, can also be used to provide the rotary movement between the booms of the crane and the telescopic movement of the extension.

FIGS. 3a to 3b illustrate the design of the crane 12 according to a second embodiment in greater detail. In this second embodiment, which is preferably used with a forest tractor using a grapple as a tool, the crane 12 includes three booms 16 articulated to each other, namely a pillar boom 40, a main boom 42 and an extension boom 30. The actuators 18 may comprise a lifting cylinder 48 between the pillar boom 40 and the main boom 42, a folding cylinder 52 between the main boom 42 and the extension boom 30, and further, an extension cylinder, not shown in the figures, within the extension boom 30. Nor does the figure show the tool suspended from the crane 12, preferably a grapple for grabbing trees in this type of cranes.

In addition, the mobile work machine 10 according to the aspects of the disclosed embodiments includes a tool 20 suspended from the crane 12 for grabbing a load 14 and a control system 22 for controlling the knuckle boom crane 12 at least partially automatically. In the case of a forest machine, the tool 20 used may be, for example, a harvester head 21 shown in FIG. 1a or a grapple 23 shown in FIG. 1 b. A great number of different harvester heads is available from different manufacturers and their own weights and characteristics and thereby the stress exerted on the crane vary tool-specifically. Therefore, the maximum reach at which the crane can be used is preferably defined for each tool.

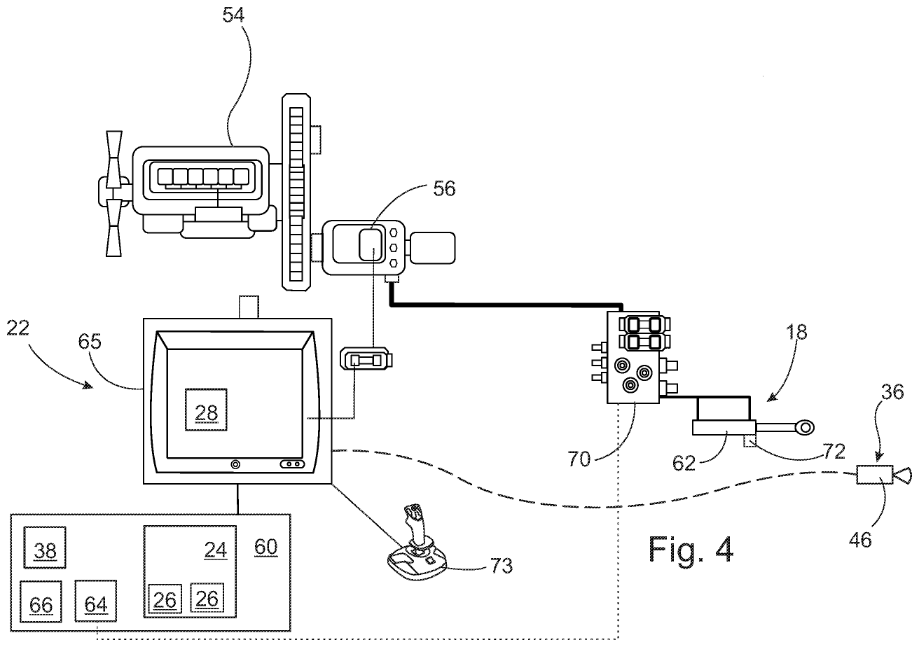

The control system 22 of a mobile work machine according to the aspects of the disclosed embodiments may include, as shown in FIG. 4, one or more sensors 72 for determining the position data of the crane, storage means 60 for storing the position data, a database 24, and for storing the software means 64 controlling the crane, and a computation unit 66 to determine the commands required to control the crane for the crane actuators, based on the position data and control rules 26. FIG. 4 shows the control system 22 in a basic level in an embodiment where the mobile work machine is a forest machine which includes an internal combustion engine 54, and a hydraulic pump 56 used with the internal combustion engine for producing a pressurized hydraulic flow for a hydraulic cylinder 62, for example, which functions as the lifting cylinder, which is a part of the crane actuators. Preferably, between the hydraulic pump 56 and the lifting cylinder 48, there is a directional valve unit 70, which is used to control the use of the actuators 18. In FIG. 4, the sensor 72 for determining the position data of the crane may be, for example, a position sensor for one or more cylinders allowing to determine the reach of the crane based on their positions.

More precisely, regarding the crane 12 according to the second embodiment shown in FIGS. 3a to 3c, preferably a tip control system is used wherein sensoring is implemented in such a way that the control system 22 includes three sensors 72, of which the first sensor 72 measures the angle of the lifting joint or the length of the lifting cylinder 48 located at the top end of the pillar boom 40. The second sensor 72, arranged at the end of the main beam 42, measures the angle and length of the folding cylinder 52, and the third sensor 72 measures the length of the extension 32 and is located in the extension.

Data produced by the sensors 72 then goes to the computation unit. 66 of the control system 22; this unit can be a programmable logic unit (PLC), which preferably computes and forms current lengths of the actuators, the crane position and the position of the extension tip, from the sensor data. In addition, the computation unit can form the necessary actuator-specific controls based on the speed control of the tip set by the driver with the joystick 73 shown in FIG. 4 so that the driver's instruction will be automatically executed regarding the tip of the crane extension. The control algorithm, or the software means, follows the positions Of the actuators calculated from the sensors and, based on this information, for example, prevents the collision of the actuators with the mechanical end. According to the aspects of the disclosed embodiments, the algorithm also follows the distance of the tip, that is, the reach, and thus stops the movement of the actuators programmatically in a controlled way once the preset maximum reach is achieved.

The control system as presented above is preferably a part of the tip control system for the crane control of a mobile work machine. The tip control system observes the position of the crane and automatically performs the movement between the crane booms so that the operator only needs to control the crane tip with one control device and not each actuator separately. It is possible to include a control rule stored in the database as an additional control condition for the tip control system thus limiting the maximum reach of the crane according to the control rule.

The computation unit 66 of the tip control system, more generally, the control system 22, may be a user interface 65 for the forest machine control as shown in FIG. 4, comprising a computation unit 66. The user interface 65 can also be used to enter control rules into the storage means 60, which can be, for example, a memory included in the user interface 65 or a memory retrievable by a remote connection, in which the database with control rules is located. The software means 64 and the database 24 have been stored in the storage means for the control rules 26. The computation unit 66 is arranged to limit the operation of the actuators of the crane by means of the control commands generated by the software means 64 based on the control rules. The control rules can be entered into the database 24 using the user interface 65, for example.

For example, when using a crane shown in FIGS. 2a and 2b, that is, the Ponsse C5 crane, the maximum reach of which is 10 m and the highest allowable lifting force approximately 15 kN, together with the Ponsse H8hd harvester head, the maximum reach of the crane can be limited from 10 meters to 8.6 meters according to the control rule. In other words, in a forest machine according to the aspects of the disclosed embodiments, a functional combination is achieved even when combining a low-capacity crane with a large felling head, that is, a harvester head. When operating with the limited maximum reach of 8.6 meters, such lifting forces are not exerted on the crane that could damage the crane, forest machine or tool, or all of these, in the long or short run. In practice, the limitation can be implemented in such a way that the control system observes the position of the crane actuator and uses the software means to determine operating limits for the actuator position, within which the actuator can be used. Thus, when the actuator is, for example, an extension cylinder that moves the telescopic extension of the extension boom, only 1600 mm of the 3000 mm stroke of the extension cylinder can be utilized, the reach of the crane thus being limited to the allowable range for protecting the crane.

FIG. 4 also shows the observation means 36 preferably included in the control system 22, which may also include, for example, the camera 46 shown in Figure la, which is used to record the surroundings of the forest machine and the surrounding trees. Alternatively, instead of a camera, a laser scanner 49 or Lidar shown in FIG. 1a can also be used as an observation sensor or another sensor suitable for the application, with which the surrounding trees can be identified. The observation means can be connected to the software means 64, which identify the trees from a point cloud using machine vision and store the observation in another database 38. Preferably, the position data that is wirelessly retrievable with positioning means 27 is also connected to the observations. Before lifting the tree, the control system retrieves the mass information of the tree to be lifted from another database as well as the position data of the crane and, based on these, computes the estimated lifting force generated by the lifting. The control rule can be a so-called lifting force rule in which the maximum allowable lifting force is determined for each tool used at each crane reach, and if the estimated lifting force is higher than the maximum allowable lifting force, the control system is arranged to prevent the lifting with the crane actuators.

An observation of the tree by the observation means may be, for example, the species of the tree, the diameter of the tree or the location of the tree. Based on this information, the magnitude of the lifting force can be estimated either directly or indirectly before lifting so that the decision for allowing or preventing lifting can be made before lifting.

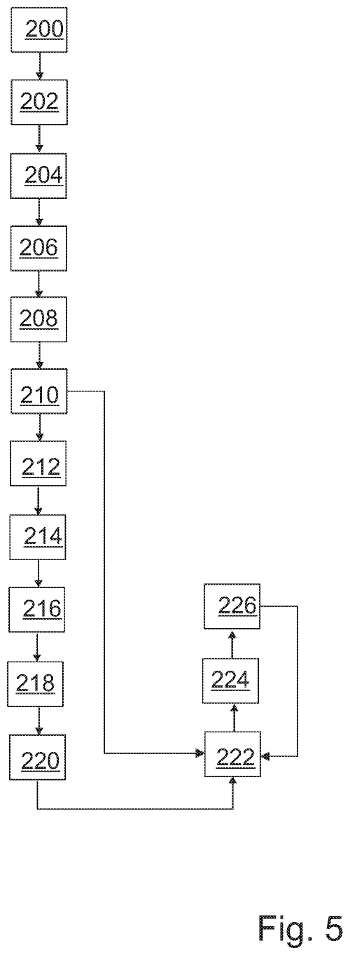

FIG. 5 illustrates the steps of the method according to the aspects of the disclosed embodiments in a block diagram. The method starts with the generation of control rules in the database in step 200. The control rules can be entered, for example, with a user interface or they can be information entered into a cloud service, for example. The control rules define the conditions under which the crane actuators are controlled in a selected way for protecting the crane. In step 202, the tool to be used is installed in the crane and in step 204, information of the tool used is entered into the control system via a user interface, for example. In step 206, the control system compares the information entered with the control rule of the database and in step 208, a limitation is retrieved from the control rule for the use of the actuator. The aforementioned steps take place before the actual use of the crane for lifting or handling trees.

After this, the crane can be used traditionally, that is, according to step 210, the tree is approached with the crane using actuators for extending out the crane in step 222, the operation of the crane actuators is limited programmatically based on the rule for protecting the crane. However, in a preferable embodiment, before the limitation in step 222, the surroundings are observed with the observation means in step 212, observations are preferably stored in another database in step 214, and in step 216, an observation is preferably retrieved from another database. In addition, in step 218, the estimated mass of the tree is calculated based on the observation, and in step 220, the maximum allowable adaptive reach is determined based on the maximum allowable reach and correlation.

The method may also include steps 224 for monitoring the fulfillment of the deviation criterion and step 226 to deviate from the control rule when the deviation criterion is fulfilled. This enables implementation of a special use of the crane and, for example, achievement of the crane's maintenance positions. For example, the deviation can be a reach larger than the control rule for a particular tool when performing thinning felling, where the mass of the trees is smaller than usual and thus also the forces exerted on the crane are more moderate. The deviation criterion may be, for example, the use of a selector or control or switch 28, which can be, for example, a software part user interface 65 as shown in FIG. 4.

1-15. (canceled)

16. A mobile work machine, which includes
a knuckle boom crane for lifting loads comprising at least two booms articulated to each other and actuators for moving the booms;
a tool fastened to the knuckle boom crane for grabbing a load;
a control system for controlling the knuckle boom crane at least partially automatically, the control system including a database comprising at least one control rule for protecting the knuckle boom crane from overloading, and the control system is adapted to programmatically protect the knuckle boom crane based on the at least one control rule by limiting operation of the actuators before actual use of the knuckle boom crane for lifting or handling a load, wherein the control rule includes a tool-specific lifting force rule limiting a maximum allowable lifting force of the knuckle boom crane at each reach of the knuckle boom crane and the knuckle boom crane has a physical maximum reach and when following the reach rule, the control system is arranged to protect the knuckle boom crane by limiting the reach of the knuckle boom crane programmatically to less than the maximum reach.

17. The mobile work machine according to claim 16, wherein the control rule includes in addition a tool-specific reach rule limiting a maximum allowable reach of the knuckle boom crane.

18. The work machine according to claim 17, the knuckle boom crane has a maximum allowable lifting force and when following the lifting force rule, the control system is arranged to protect the knuckle boom crane by programmatically preventing the knuckle boom crane from lifting when the maximum allowable lifting force is exceeded.

19. The work machine according to claim 16, wherein the booms include an extension boom comprising a telescopically movable extension and the actuators include a first actuator for using the extension of the extension boom and the control system is adapted to control the operation of the first actuator for limiting the reach of the knuckle boom crane programmatically to a limited reach.

20. The work machine according to claim 16, wherein the database includes at least one allowable deviation criterion from the control rule, upon fulfillment of which the control system is arranged to override the control rule.

21. The work machine according to claim 16, wherein the mobile work machine is a forest machine and the loads to be lifted with the knuckle boom crane are trees.

22. The forest machine according to claim 21, wherein the forest machine includes an observation system to form observations of trees surrounding the forest machine and storing observations in another database, where the observation is one or more of the following characteristics of the tree: diameter, species, location, length, volume, size, dimensions; and the control system is arranged to use the observations for implementing a limitation of the actuator according to the control rule.

23. The forest machine according to claim 22, wherein the database includes a correlation for the lifting force rule, the correlation being a function of the lifting force exerted by the lifting of the tree on the knuckle boom crane and the current reach of the knuckle boom crane.

24. The forest machine according to claim 23, wherein the control system is arranged to:
calculate an estimated mass of the tree based on the observation, determine an adaptive maximum allowable reach using the maximum allowable reach and correlation,
limit the reach of the knuckle boom crane according to the adaptive maximum allowable reach.

25. A method for a mobile work machine where the mobile work machine includes
a knuckle boom crane for lifting loads comprising at least two booms articulated to each other and actuators for moving the booms;
a tool suspended from the knuckle boom crane for grabbing a load;
a control system for controlling the knuckle boom crane at least partially automatically, wherein the control system includes a database comprising at least one control rule for protecting the knuckle boom crane from overloading, the method involving
controlling of the knuckle boom crane at least partially automatically using the control system for grabbing a load;
protecting the knuckle boom crane with the control system programmatically based on the control rule by limiting the operation of the actuators before the actual use of the knuckle boom crane for lifting or handling a load, wherein the control rule includes a tool-specific lifting force rule limiting a maximum allowable lifting force of the knuckle boom crane at each reach of the knuckle boom crane and the knuckle boom crane has a physical maximum reach and when following the reach rule, the control system is arranged to protect the knuckle boom crane by limiting the reach of the knuckle boom crane programmatically to less than the maximum reach.

26. The method according to claim 25, wherein, in addition to the tool-specific lifting force rule, a maximum allowable reach of the knuckle boom crane is limited using a reach rule.

27. The method according to claim 25, the mobile work machine being a forest machine and trees being the loads to be lifted and the method involves steps of:
observing of the surrounding trees to form observations; and
adaptively protecting the knuckle boom crane based on the observations and the control rule.

28. The method according to claim 27, wherein the knuckle boom crane is adaptively protected based on observations and the control rule in the following steps performed by the control system:
calculating an estimated mass of the tree based on the observation;
determining an adaptive maximum allowable reach using the maximum allowable reach and correlation;
limiting the reach of the knuckle boom crane according to the adaptive maximum allowable reach.
